(19) United States
(12) Patent Application Publication
(10) Pub. No.: US 2026/0152076 A1
(43) Pub. Date: Jun. 4, 2026

(54) ELECTRIC VEHICLE

(71) Applicant: TOYOTA JIDOSHA KABUSHIKI KAISHA, Toyota-shi (JP)

(72) Inventor: Gohki KINOSHITA, Toyota-shi (JP)

(73) Assignee: TOYOTA JIDOSHA KABUSHIKI KAISHA, Toyota-shi (JP)

(21) Appl. No.: 19/393,746

(22) Filed: Nov. 19, 2025

(30) Foreign Application Priority Data
Dec. 2, 2024 (JP) 2024-209589

(51) Int. Cl. B60L 15/20; B60L 7/16; B60L 50/60

(52) U.S. Cl. CPC B60L 15/2009; B60L 7/16; B60L 50/60; B60L 2240/421; B60L 2240/423; B60L 2240/507; B60L 2260/26

(57) ABSTRACT

An electric vehicle includes a first motor connected to one of front and rear wheels, a second motor connected to the other wheels, a battery exchanging power with the motors, a clutch connecting and disconnecting the first motor and the wheels, and an electronic control unit. When braking force is required under a condition where maximum input power to the battery is limited, the control unit turns off the clutch to disconnect the first motor, and then controls the first motor in power running and the second motor in regeneration to achieve braking.

### CROSS-REFERENCE TO RELATED APPLICATION

The present disclosure claims priority to Japanese Patent Application No. 2024-209589 filed on Dec. 2, 2024, which is incorporated herein by reference in its entirety including specification, drawings and claims.

### TECHNICAL FIELD

The present disclosure relates to the electric vehicle.

### BACKGROUND

Conventionally, as this type of electric vehicle, proposals have been made for one equipped with the motor as the drive source and the battery capable of both supplying electric power to the motor and charging electric power generated by the motor, and configured to switch between the four-wheel drive travel in which the front and rear wheels are driven and the two-wheel drive travel in which either the front wheels or the rear wheels are driven (see, for example, Patent Document 1).

### CITATION LIST

### Patent Literature

PTL 1: JP 2016-159806

### SUMMARY

In the above-described electric vehicle, the vehicle can be decelerated while charging the battery by performing regenerative control of the motor. However, when the maximum chargeable power to the battery is limited, sufficient braking force cannot be output from the motor. Although it is conceivable to output the required braking force by the mechanical brake instead of the regenerative control of the motor, the frequency of use of the mechanical brake increases, which may reduce its lifetime.

The main purpose of the of the electric vehicle of the present disclosure is to output the sufficient braking force by regenerative control of the motor while avoiding the excessive electric power from being input to the energy storage device.

The electric vehicle of the present disclosure has adopted the following means in order to achieve the above principal object.

The electric vehicle of the present disclosure comprises:
a first motor connected to one of front wheels and rear wheels;
a second motor connected to the other of the front wheels and the rear wheels;
an energy storage device capable of exchanging electric power with the first motor and the second motor;
a connection release mechanism configured to connect and disconnect the first motor and said one wheel; and
a control unit programmed, when an output of braking force is requested during running, to control the connection release mechanism such that the first motor is disconnected from said one wheel, and thereafter to perform drive control of the first motor and regenerative control of the second motor.

In the electric vehicle of the present disclosure, when an output of braking force is requested during running, the first motor that is disconnected from one of front wheels and rear wheels is subjected to drive control, and the second motor connected to the other of the front wheels and the rear wheels is subjected to regenerative control. As a result, at least a part of electric power generated by the regenerative control of the second motor can be consumed by the drive control of the first motor. Consequently, it is possible to avoid excessive electric power from being input into the energy storage device while outputting sufficient braking force by the regenerative control of the second motor.

In the electric vehicle of the present disclosure, the control unit may set braking power required by the vehicle, perform regenerative control of the second motor such that the braking power is output, and perform drive control of the first motor such that surplus power, which exceeds maximum power inputtable into the energy storage device from electric power generated by the regenerative control of the second motor, is consumed. In this way, by the regenerative control of the second motor, the required braking power can be output while charging the energy storage device within a range not exceeding the maximum inputtable power.

Further, in the electric vehicle of the present disclosure, an engine connected to a rotation shaft of the first motor may be provided, and the control unit may perform drive control of the first motor such that the engine is motored when an output of braking force is required during traveling. In this way, electric power generated by regenerative control of the second motor can be consumed not only by losses of the first motor and an inverter driving the first motor, but also by losses of the engine. Accordingly, surplus power exceeding maximum power inputtable into the energy storage device, among electric power generated by the regenerative control of the second motor, can be consumed more reliably by the drive control of the first motor.

### BRIEF DESCRIPTION OF DRAWINGS

FIG. 1 shows the schematic configuration diagram of the electric vehicle of the present disclosure.

FIG. 2 shows the flowchart illustrating an example of the accelerator-Off deceleration process.

FIG. 3 shows the explanatory diagram illustrating an example of the map for setting the deceleration request torque.

FIG. 4 shows the explanatory diagram illustrating an example of the map for setting the target rotational speed.

FIG. 5 shows the schematic configuration diagram of the other electric vehicle.

### DESCRIPTION OF EMBODIMENTS

Next, embodiments for carrying out the present disclosure will be described.

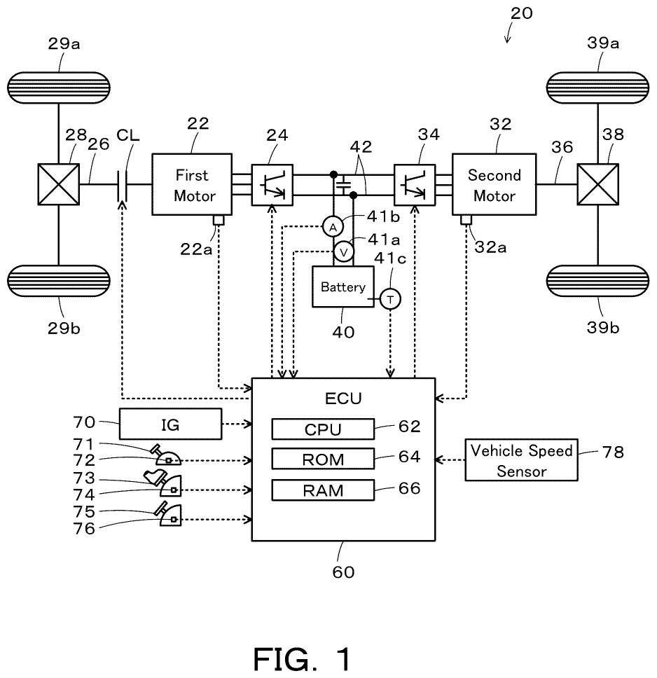

FIG. 1 shows a schematic configuration diagram of the electric vehicle 20 of the present disclosure. The electric vehicle 20 is configured as an electric automobile, and as shown in FIG. 1, includes a first motor 22, a first inverter 24, a second motor 32, a second inverter 34, a battery 40, a clutch CL, and an electronic control 60.

The first motor 22 and the second motor 32 are configured, for example, as synchronous motor-generators. A rotor (not shown) of the first motor 22 is connected to a drive shaft 26 via a clutch CL. The drive shaft 26 is connected to front wheels 29a and 29b via a differential gear 28. A rotor (not shown) of the second motor 32 is connected to a drive shaft 36. The drive shaft 36 is connected to rear wheels 39a and 39b via a differential gear 38. The rotor of the first motor 22 may be connected to the drive shaft 26, which is connected to the front wheels 29a and 29b via the differential gear 28, and the rotor of the second motor 32 may be connected to the drive shaft 36, which is connected to the rear wheels 39a and 39b via the differential gear 38, via the clutch CL. The first motor 22 and the second motor 32 are provided with rotor position sensors 22a and 32a for detecting the rotational positions of the rotors.

The first inverter 24 and the second inverter 34 are configured as known inverter circuits each having six transistors and six diodes. The first inverter 24 and the second inverter 34 are connected to a power line 42. The first inverter 24 converts direct-current power from the battery 40 into three-phase alternating current by PWM control, applies it to the first motor 22, and drives the first motor 22. Similarly, the second inverter 34 converts direct-current power from the battery 40 into three-phase alternating current by PWM control, applies it to the second motor 32, and drives the second motor 32.

The battery 40 is configured, for example, as a lithium-ion battery. The battery 40 is connected to the first inverter 24 and the second inverter 34 via the power line 42. A smoothing capacitor is attached to the power line 42. A voltage sensor 41a for detecting a battery voltage Vb is attached across both terminals of the battery 40. A current sensor 41b for detecting a battery current Ib is attached to a terminal of the battery 40. A temperature sensor 41c for detecting a battery temperature Tb is attached to the battery 40.

The electronic control unit 60 is programmed as a microcomputer centered on a CPU 62. The electronic control unit 60 includes, in addition to the CPU 62, a ROM 64, a RAM 66, an input port (not shown), an output port (not shown), and the like.

The electronic control unit 60 receives, via the input port, a rotational position θ1 of the first motor 22 and a rotational position θ2 of the second motor 32 detected by rotational position sensors 22a and 32a, respectively, a battery voltage Vb detected by the voltage sensor 41a, a battery current Ib detected by the current sensor 41b, and a battery temperature Tb detected by the temperature sensor 41c. The electronic control unit 60 calculates a rotational speed N1 of the first motor 22 based on the rotational position θ1 of the first motor 22, and calculates a rotational speed N2 of the second motor 32 based on the rotational position θ2 of the second motor 32. The electronic control unit 60 calculates a state of charge (SOC) of the battery 40 based on an integrated value of the battery current Ib. The state of charge SOC represents a ratio of the capacity of dischargeable power from the battery 40 to the total capacity of the battery 40. The electronic control unit 60 also sets an input limit Win (negative value) and an output limit Wout (positive value) based on the state of charge SOC of the battery 40 and the battery temperature Tb. The input limit Win is a maximum value of input power allowable for the battery 40. The output limit Wout is a maximum value of output power allowable for the battery 40. The input limit Win and the output limit Wout can be set by multiplying a temperature-dependent value based on the battery temperature Tb by a correction coefficient based on the state of charge SOC of the battery 40.

The electronic control unit 60 also receives a start signal ST from a start switch 70, a shift position SP detected by a shift lever position sensor 72 attached to a shift lever 71, an accelerator opening degree Acc detected by an accelerator pedal position sensor 74 attached to an accelerator pedal 73, and a brake pedal position BP detected by a brake pedal position sensor 76 attached to a brake pedal 75. The electronic control unit 60 further receives a vehicle speed V detected by a vehicle speed sensor 78.

In the electric vehicle 20 configured as described above, there are provided a two-wheel driving mode and a four-wheel driving mode as driving modes. The two-wheel driving mode is a mode in which the clutch CL is disengaged to disconnect the first motor 22 from the front wheels 29a and 29b, and the rear wheels 39a and 39b are driven by the second motor 32 for traveling. The four-wheel driving mode is a mode in which the clutch CL is engaged to connect the first motor 22 to the front wheels 29a and 29b, and the front wheels 29a and 29b and the rear wheels 39a and 39b are driven by the first motor 22 and the second motor 32 for traveling.

In the two-wheel driving mode, a CPU 62 of the electronic control unit 60 sets a driving request torque Td* required for traveling based on an accelerator opening Acc and a vehicle speed V. Subsequently, the CPU 62 calculates a driving request power Pd* by multiplying the driving request torque Td* by the vehicle speed V. Next, the CPU 62 sets an execution power P* such that the driving request power Pd* is output within a range of an input limit Win and an output limit Wout of the battery 40. Then, the CPU 62 sets a target torque T2* of the second motor 32 by dividing the execution power P* by a rotational speed N2 of the second motor 32. When the CPU 62 sets the target torque T2*, the CPU 62 performs switching control of transistors of the second inverter 34 such that the target torque T2* is output from the second motor 32.

In the four-wheel driving mode, a CPU 62 sets an execution power P* in the same manner as in the two-wheel driving mode described above. Subsequently, the CPU 62 distributes the execution power P* between front and rear according to a front/rear distribution ratio corresponding to a traveling state, and obtains a front-wheel execution power Pf* and a rear-wheel execution power Pr*. Next, the CPU 62 sets a target torque T1* of the first motor 22 by dividing the front-wheel execution power Pf* by a rotational speed N1 of the first motor 22, and sets a target torque T2* of the second motor 32 by dividing the rear-wheel execution power Pr* by a rotational speed N2 of the second motor 32. When the CPU 62 sets the target torques T1* and T2*, the CPU 62 performs switching control of transistors of the first inverter 24 such that the target torque T1* is output from the first motor 22, and performs switching control of transistors of the second inverter 34 such that the target torque T2* is output from the second motor 32.

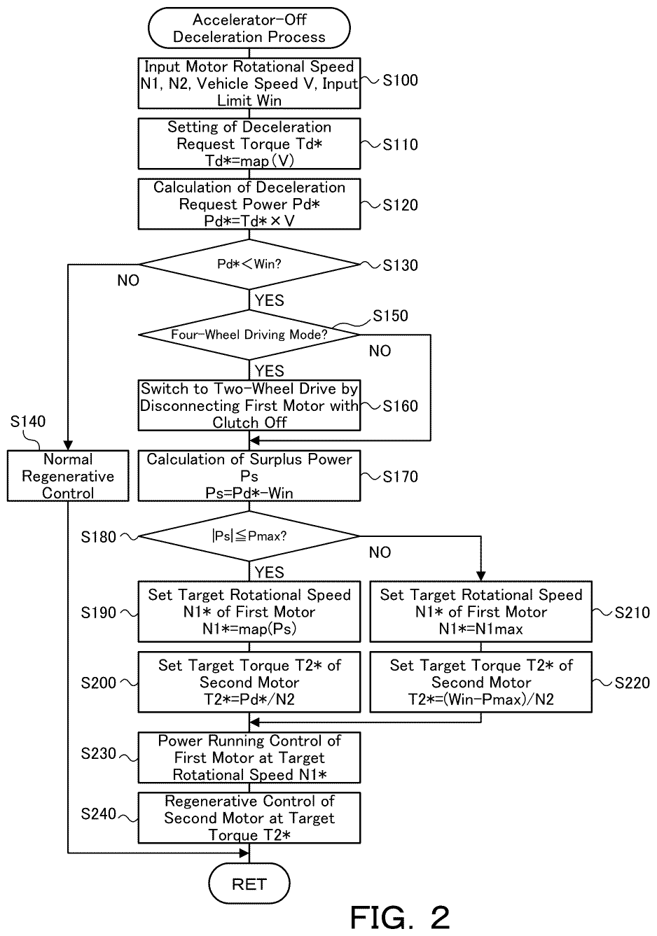

Next, an operation performed when decelerating with the accelerator pedal 83 released during travel will be described. FIG. 2 shows a flowchart illustrating an example of an accelerator-off deceleration process, which is executed by the electronic control unit 60. This process is repeatedly executed at predetermined intervals when the accelerator pedal 83 is released during travel.

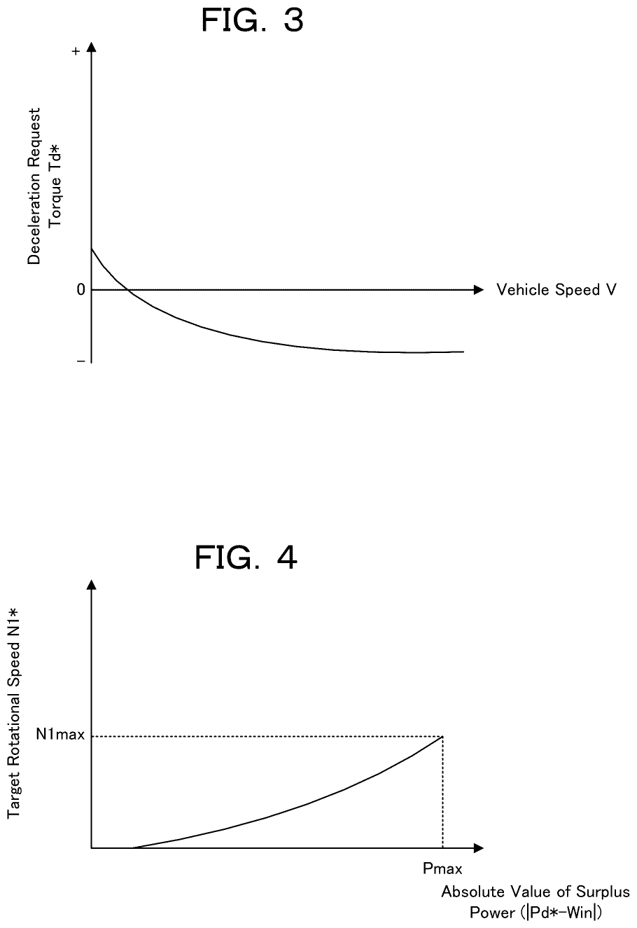

When the deceleration process during accelerator-off is executed, a CPU 62 of the electronic control unit 60 first inputs the rotational speed N1 of the first motor 22, the rotational speed N2 of the second motor 32, the vehicle speed V, and the input limit Win of the battery 40 (step S100). Subsequently, the CPU 62 sets a deceleration request torque Td* as a negative driving request torque based on a deceleration request torque map and the vehicle speed V (step S110). FIG. 3 is an explanatory diagram showing an example of the deceleration request torque map. In a case where the electric vehicle 20 has a travel mode in which acceleration and deceleration are performed only by operating the accelerator pedal 83, the CPU 62 may set the deceleration request torque Td* based on the accelerator opening degree Acc in addition to the vehicle speed V.

Next, the CPU 62 calculates a deceleration request power Pd* as a negative driving request power by multiplying the deceleration request torque Td* by the vehicle speed V (step S120). Then, it is determined whether the deceleration request power Pd* is less than the input limit Win (step S130). This process is for determining whether power exceeding the input limit Win will be input to the battery 40 when regenerative control of the first motor 22 and the second motor 32 is performed such that the deceleration request power Pd* is output. A situation in which the deceleration request power Pd* becomes less than the input limit Win is likely to occur when the battery temperature Tb is not within the proper range or when the state of charge (SOC) of the battery is close to full charge, whereby the maximum power that can be input to the battery 40 (the input limit Win) is restricted. Therefore, in step S130, the CPU 62 may determine whether the battery temperature Tb is within the proper temperature range and whether the SOC is less than a predetermined ratio close to full charge.

When the CPU 62 determines that the deceleration request power Pd* is not less than the input limit Win, it performs regenerative control of the first motor 22 and the second motor 32 such that the deceleration request power Pd* is output (step S140), and ends the deceleration control process at accelerator-off. Specifically, when the current driving mode is the two-wheel driving mode, the CPU 62 divides the deceleration request power Pd* by the rotational speed N2 of the second motor 32 to set a target torque (regenerative torque) T2* of the second motor 32, and controls the second inverter 34. When the current driving mode is the four-wheel driving mode, the CPU 62 determines a front-wheel request power Pf* and a rear-wheel request power Pr* based on the deceleration request power Pd* and the front-rear distribution ratio, divides the front-wheel execution power Pf* by the rotational speed N1 of the first motor 22 to set a target torque T1* of the first motor 22, and divides the rear-wheel execution power Pr* by the rotational speed N2 of the second motor 32 to set a target torque T2* of the second motor 32, and controls the first inverter 24 and the second inverter 34.

On the other hand, when the CPU 62 determines that the deceleration request power Pd* is less than the input limit Win, it determines whether or not the vehicle is in the four-wheel driving mode (step S150). When the CPU 62 determines that the vehicle is in the four-wheel driving mode, it switches to the two-wheel driving mode by turning off the clutch CL to disconnect the first motor 22 from the front wheels 29a and 29b (step S160), and then proceeds to step S170. When the CPU 62 determines that the vehicle is not in the four-wheel driving mode but is in the two-wheel driving mode, it maintains the two-wheel driving mode and proceeds to step S170.

Next, the CPU 62 sets the surplus power Ps (=Pd* −Win) by subtracting the input limit Win from the deceleration request power Pd* (step S170). Subsequently, the CPU 62 determines whether or not the absolute value of the surplus power Ps (|Ps|) is equal to or less than the maximum consumable power Pmax (step S180). The maximum consumable power Pmax is the maximum power that can be consumed by driving the first motor 22 up to the allowable maximum rotational speed N1max in a state where the first motor 22 is disconnected from the front wheels 29a and 29b (no-load state).

When the CPU 62 determines that the absolute value of the surplus power Ps is equal to or less than the maximum consumable power Pmax, it judges that the surplus power Ps can be consumed by the power running control of the first motor 22, and sets a target rotational speed N1* of the first motor 22 based on the target rotational speed setting map and the absolute value of the surplus power Ps (step S190). The target rotational speed N1* is the rotational speed of the first motor 22 necessary to consume the surplus power Ps when the first motor 22 is disconnected from the front wheels 29a and 29b and controlled in a no-load state. FIG. 4 is an explanatory diagram showing an example of the target rotational speed setting map. The target rotational speed N1* is set higher as the absolute value of the surplus power Ps increases. Subsequently, the CPU 62 divides the deceleration request power Pd* by the rotational speed N2 of the second motor 32 to set the target torque (regenerative torque) T2* of the second motor 32 (step S200). The CPU 62 then controls the first inverter 24 such that the first motor 22 rotates at the target rotational speed N1* (step S230), and also controls the second inverter 34 such that the target torque T2* is output from the second motor 32 (step S240), thereby ending the deceleration process during accelerator-off.

While the first motor 22, disconnected from the front wheels 29a and 29b, is controlled for power running, the second motor 32, connected to the rear wheels 39a and 39b, is controlled for regeneration. As a result, part of the electric power generated by the regeneration of the second motor 32 is consumed by the no-load losses of the first motor 22, the no-load losses of the power transmission mechanism on the side of the first motor 22 via the clutch CL, and the switching losses of the first inverter 24. Accordingly, even when the input limit Win of the battery 40 is restricted, it is possible to avoid an excessive electric power exceeding the input limit Win from being input to the battery 40. Thus, the deceleration request power Pd* can be output by the regenerative control of the second motor 32 to perform deceleration driving.

In step S180, when the CPU 62 determines that the absolute value of the surplus power Ps is greater than the maximum consumable power Pmax (the power consumed when the first motor 22 is rotated at the maximum rotational speed N1max), the CPU 62 determines that the surplus power Ps cannot be consumed by the power-running control of the first motor 22, and sets the target rotational speed N1* of the first motor 22 to the maximum rotational speed N1max (step S210). Next, the CPU 62 calculates a value obtained by subtracting the maximum consumable power Pmax from the input limit Win of the battery 40, divides the value by the rotational speed N2 of the second motor 32, and sets the target torque (regeneration torque) T2* of the second motor 32 (step S220). Then, the CPU 62 controls the first inverter 24 such that the first motor 22 rotates at the target rotational speed N1* (step S230), and controls the second inverter 34 such that the target torque T2* is output from the second motor 32 (step S240), thereby completing the deceleration process upon accelerator-off. As a result, the second motor 32 is controlled for regeneration such that the electric power does not exceed the sum of the maximum input power to the battery 40 (input limit Win) and the maximum consumable power Pmax consumed by the power-running control of the first motor 22. Accordingly, it is possible to more reliably avoid the situation where electric power exceeding the input limit Win is input to the battery 40.

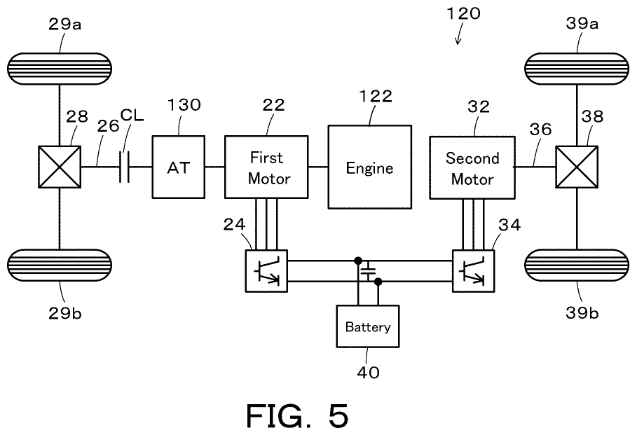

In the above-described embodiment, the electric vehicle 20 is configured as an electric vehicle including the first motor 22, the second motor 32, the battery 40, and the clutch CL. However, the electric vehicle 20 may also be a hybrid vehicle (including a plug-in hybrid vehicle) equipped with an engine in addition to the same hardware configuration as the electric vehicle. Furthermore, the electric vehicle 20 may also be a fuel cell vehicle equipped with a fuel cell in addition to the same hardware configuration as the electric vehicle. For example, as shown in the electric vehicle 120 illustrated in FIG. 5, in addition to the first motor 22 and the second motor 32, the vehicle may include an engine 122 having an output shaft connected to the rotor of the first motor 22, and an automatic transmission 130 having an input shaft connected to the rotor of the first motor 22 and an output shaft connected to the drive shaft 26 via the clutch CL, thereby being configured as a hybrid vehicle. In this case, while the first motor 22 is power-run controlled with the clutch CL disengaged to disconnect it from the front wheels 29a and 29b, the second motor 32 connected to the rear wheels 39a and 39b is regeneration controlled, such that the power generated by regeneration of the second motor 32 can be consumed not only by the losses of the first motor 22 and the first inverter 24, but also by the losses of the engine 122. As a result, the surplus power Ps can be consumed more reliably by the power-running control of the first motor 22, thereby more reliably avoiding the situation in which excessive power exceeding the input limit Win is input to the battery 40.

The correspondence between the principal elements of the embodiment and the principal elements of the disclosure described in the Summary section will be explained. The first motor 22 of this embodiment corresponds to the first motor of the present disclosure, the second motor 32 corresponds to the second motor, the battery 40 corresponds to the power storage device, the clutch CL corresponds to the connection release mechanism, and the electronic control unit 60 corresponds to the control unit. In addition, the engine 122 corresponds to the engine.

It should be noted that the correspondence between the principal elements of the embodiment and the principal elements of the disclosure described in the Summary section is merely an example for specifically explaining an embodiment that implements the disclosure described in the Summary section, and does not limit the elements of the disclosure described in that section. In other words, the interpretation of the disclosure described in the Summary section should be based on the description of that section, and the embodiment is nothing more than a specific example of the disclosure described in the Summary section.

As described above, embodiments have been explained as modes for carrying out the present disclosure. However, the present disclosure is not limited to such embodiments, and it is of course possible to implement the present disclosure in various forms without departing from the spirit thereof.

### INDUSTRIAL APPLICABILITY

The present disclosure is applicable to the manufacturing industry of electric vehicles.

What is claimed is:

1. An electric vehicle comprising:
a first motor connected to one of front wheels and rear wheels;
a second motor connected to the other of the front wheels and the rear wheels;
a power storage device capable of exchanging power with the first motor and the second motor;
a connection release mechanism that connects and disconnects the first motor and the one of the wheels; and
a control unit programmed to, when output of braking force is required during traveling, control the connection release mechanism such that the first motor is disconnected from the one of the wheels, and thereafter perform power running control on the first motor and regenerative control on the second motor.

2. The electric vehicle according to claim 1,
wherein the control unit is programmed to, when output of braking force is required during traveling, set braking power required by the vehicle, perform regenerative control on the second motor such that the braking power is output, and perform power running control on the first motor such that surplus power exceeding a maximum power inputtable into the power storage device among electric power generated by the regenerative control of the second motor is consumed.

3. The electric vehicle according to claims 1, further comprising an engine connected to a rotating shaft of the first motor,
wherein the control unit is programmed to, when output of braking force is required during traveling, perform power running control on the first motor such that the engine is motored.
